(19) United States
(12) Patent Application Publication
(10) Pub. No.: US 2008/0165965 A1
(43) Pub. Date: Jul. 10, 2008

(54) METHOD OF TWO STRINGS PRIVATE KEY (SYMMETRIC) ENCRYPTION AND DECRYPTION ALGORITHM

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/620,568

(22) Filed: Jan. 5, 2007

(51) Int. Cl. H04K 1/00; H04L 9/28; H04L 9/30

(52) U.S. Cl. 380/255; 380/28; 380/30

(57) ABSTRACT

Two strings encryption algorithm where a long and a short strings are used. The byte values of the short string points to a location of the long string and the plaintext is aligned with the long string and encryption is performed using the long string's byte values and the plaintext the process is repeated for all bytes of the short string. The short string defines the encryption strength by pointing to the long string encrypting at first and re-encrypting thereafter. At the end, once the encryption is finished, the short key byte's values are used and once again pointing to the long string and removing a byte from the location and the removed byte(s) form a third string. The process will repeat until all the bytes values from the first string are used and a third string of equal length as of the short string is formed. Finally, the third string will perform the same process and its byte's values are used to point the long string and insert a byte of the short string into the location where they're pointing to, the process will repeat until all bytes of the short string are inserted into the long string. The long and short (third) strings are now unbalanced and the third (short) string becomes the private content's key. The reverse process is used to remove the short string, insert the third string and have two balanced string and decryption can be performed thereafter.

### BACKGROUND OF INVENTION

1. Field of the Invention

The field of this invention relates to a method for encrypting and decrypting using two-strings key pair for the encryption and decryption algorithm. The two strings can be of the same length or two distinct lengths. One string is for encryption combinations and the other is of encryption strength.

2. Prior Art

The prior art of Massey, et al. U.S. Pat. No. 5,214,703 teaches a kind of block encryption that makes use of all known encryption techniques of confusion, diffusion, etc. and, above all, will use a longer key providing first input means for receiving at least two initial sub-blocks, wherein the initial digital block is subdivided to form the initial sub-blocks. Each of the initial sub-blocks has m digits. A second input means is provided for receiving at least two control blocks, each control block also having m digits. Logic means perform serial operations of at least two different types upon the initial sub-blocks and the control blocks. The logic means include at least four operation units, each having first and second inputs for receiving blocks to be operated upon and an output for sending an output block resulting from the logical operation performed. The blocks operated upon and the output block each have m digits. The blocks operated upon by the operation units include the initial sub-blocks, the control blocks, and the output blocks.

Massey, et al requires complex computations for its use and it does not addresses the need for protecting content for individual users and small organizations by enabling a simple yet secure means for generating a unique personalized encryption key for each individual, organization or content at runtime. It is the object of this invention to provide an easy of use, simple, secure and affordable means of encryption that can be generated at runtime and unique keys be assigned to each individual user, organization's department, individual content, etc. without compromising security.

### SUMMARY OF THE INVENTION

It is the object of this invention to demonstrate a method of generating private keys based on two key-strings, a long and a short one are used, but they as well can be two strings in equal length. The long string is used to encrypt/decrypt and the short string is used as a guiding to where encryption/decryption will take place at the long string and for encryption strength. After encryption is done the short string will point to the long string and remove bytes from it and form another short string (third string). Thereafter the newly formed short third-string will point to the long string and hide the original short string into the long string, thus, creating two unbalanced one, a long and a short strings. The short string that was removed from the long string becomes the private key of the ciphertext. This means will allow private keys to be generated for each content or user at runtime without requiring a complex computation means and/or complex hardware mechanism. Also, provide easy, secure and affordable means for sending encrypted content over a non-secure channel; to be used in smart cards and to protect contents stored on personal devices.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates the complete concept of private key system using two strings for encryption/decryption and to produce the private content's key.

FIG. 1a illustrates a server communicating with a client over a network/Intener and a smart card.

FIG. 2 illustrates the XOR of two numbers (9 and 7) and their results is the number “1”.

FIG. 2a illustrates the binary explanation for FIG. 2.

FIG. 3 illustrates the XOR of two numbers (1 and 7) and their results is the number “9”.

FIG. 3a illustrates the binary explanation for FIG. 3.

FIG. 4 illustrates the XOR of two numbers (9 and 1) and their results is the number “1”.

FIG. 4a illustrates the binary explanation for FIG. 4.

FIGS. 5-7 illustrate a string being encrypted by a long string at the location pointed by the short string.

FIGS. 8-10 illustrate a string that was encrypted by the FIGS. 5-7 being decrypted by a long string at the location pointed by the short string.

FIG. 11 illustrates how the encryption process takes place at the long string.

FIG. 12 illustrates a long string as it is encrypted with the arrangement of FIG. 11.

FIGS. 13-16 illustrate the creation of the content's private key by removing it from the long string.

FIGS. 17-20 illustrate the original short string being hidden into the long string.

FIGS. 21-25 illustrate the reverse process of FIGS. 17-20.

FIGS. 26-29 illustrate the reverse process of FIGS. 13-16.

FIG. 30 illustrates a PIN/Password having its byte values pointing to the long string.

FIG. 31 illustrates a third string formed from copies of bytes of the long string where the PIN/Password bytes values of FIG. 30 were pointing.

FIGS. 32-34 illustrates a further embodiments of FIG. 30 PIN/Password values pointing to the long string and a copy of its bytes values form a third string, next the new string and the long string bytes values are used to encrypt the PIN/Password (plaintext) and finally having the ciphertext.

FIG. 35 illustrates a process using a user's PIN/Password to create a new short string from the long string without destabilizing it, then using the new short string along with the long string to encrypt plaintext.

FIG. 36 illustrates how to increase the encryption strength and speed.

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

One of the preferred embodiments of this invention involves a two-string pair; a long and a short string are used to perform encryption/decryption of plaintext. A short string bytes values are used to point to locations at the long string representing the values of the short string's bytes values. Next aligning the plain text with the location at the long string that the byte value of the short string is pointing to. The encryption process will be repeated and the ciphertext will be re-encrypted based on the number of bytes of the short string. Decryption will be just the opposite of the encryption. Please see independent claim #1 and independent claim #10.

One other preferred embodiments of this invention involves using a user's PIN/Password to point to the long string and copy its bytes values and form a short string, then the short string will be used along with the long string to encrypt the user's PIN/Password and sent the encrypted PIN/Password along with the long stable string over a non-secure connection to a server and once the server receives them, it will use the user's PIN/Password stored therein and recreate the short string and decrypt the encrypted user's PIN/Password and if it matches the user's PIN/Password stored therein the user will be authenticated, thus allowing the user to use the server's resources. Please see independent claim #19.

In yet another embodiments of this invention, the user's entered PIN/Password is saved at the client computer without compromising its security. A long string and a short strings are used. They both can be derived (computer generated) and used to encrypt/decrypt the user's PIN/Password and have it (ciphertext) stored at a cookie variable, or any other means, at the client computer. The short string and the long string can be sent to the server computer, and they both will be in their stable states. In subsequent trips between the client and the server computer may pass them back in a hidden form element, or any other means, as needed. The client computer will use them to decrypt/encrypt and save the user's PIN/Password or any other sensitive information needed by the client computer and stored therewith. Please see independent claim #1.

In another preferred embodiments of this invention, a two-strings pair, a short and a long one are used to produce a private key. The short string's bytes values will point to the long string and remove the bytes values from it and form a third short string. The newly formed third string will then point the long string and insert the original short string into it, thus creating two unstable strings and the remaining short string (string removed from the long string) will be used as the private key. Please see independent claim #13.

In yet another preferred embodiments of this invention, a user's PIN/Password bytes values are used to point to the long string and copy the byte value where it is pointing to and form a second short string. The newly formed short string will be used along with the long string to encrypt plaintext and produce ciphertext, then have the ciphertext along with the long stable string transmitted to a server computer in a non-secure communication network/Internet. The server will use the user's PIN/Password stored therein and recreate the short string from the long string and decrypt the ciphertext. Please see independent claim #24.

Still in yet another embodiments of this invention, a user's PIN/Password along with a two-strings pair are used to secure user's contents stored at a device like but not limited to: personal computer, laptop computer, PDA, cell phone, etc. The short and long strings are used to encrypt the plaintext/contents and the user's PIN/Password is used to point to the long string and copy its bytes values and form a third short string. The third short sting will be used along with the long string and encrypt the short string that is used along with the long string to encrypt/decrypt contents. The encrypted short string can be saved with the long stable string without any means to decrypt contents without the user's PIN/Password. The user's PIN/Password and the third short string need not be saved at the device. Once the user changes his/her PIN/Password, the old PIN/Password will be used to decrypt the short string then the new user's PIN/Password will be used to encrypt the short string and have it saved at the device's storage means. Please see independent claim #24.

As will be appreciated by one of skill in the art, the present invention may be embodied as a method or a computer program product. Accordingly, the present invention may take a form of an entirely software embodiments or an embodiments combining software and hardware. Furthermore, the present invention may take the form of a computer program product on a computer-readable storage medium having computer-readable program code means embodied in the medium. Any computer readable medium may be utilized including but not limited to: hard disks, CD-ROMs, optical storage devices, or magnetic devices.

Also, any reference to names of a product or of a company is for the purpose of clarifying our discussion and they are registered to their respective owners.

I) Encryption Theory.

Encryption is the process of disguising intelligible information, called plaintext, to hide its substance from eavesdroppers. Encrypting plaintext produces unintelligible data called ciphertext. Decryption is the process of converting ciphertext back to its original plaintext. Using encryption and decryption, two parties can send messages over an insecure channel without revealing the substance of the message to eavesdroppers.

A cryptographic algorithm or cipher is a mathematical function used in the encryption and decryption of data. Many cryptographic algorithms work in combination with a key to encrypt and decrypt messages. The key, typically a large random number, controls the encryption of data by the cryptographic algorithm. The same plaintext encrypts to different ciphertext with different keys. In general, it is extremely difficult to recover the plaintext of a message without access to the key, even by an eavesdropper having full knowledge of the cryptographic algorithm.

One type of cryptographic algorithm is known as public key algorithms, it uses different keys for encryption and decryption. An encryption key, also called the public key, is used for encrypting data and is accessible to other users. Anyone can use the public key to encrypt messages. A decryption key, also called the private key, is kept secret and is used to decrypt messages. Only a person with the private key can decrypt messages encrypted with the corresponding public key. During use, the sender encrypts a message using the public key of the intended recipient. Only the intended recipient can decipher the message using his private key. Since the private key is not distributed, public key algorithms avoid the problems of key exchange inherent in symmetric algorithms.

One of the most popular public key algorithms is the RSA algorithm, named after its three inventors—Ron Rivest, Adi Shamir, and Leonard Adleman. The RSA algorithm takes a message M and encrypts it using the formula C=ME mod N, where N is the product of two large primes numbers P, Q chosen at random. The exponent E is a number relatively prime to (P−1)(Q−1). The encrypted message C is deciphered using the formula M=CD mod N where D=E−1 mod((p−1)(q−1)). The exponent E and modulus N are used as the public key. The exponent D is the private key. The primes P and Q are not needed once the public and private keys have been computed but should remain secret.

II) The Symmetric (Private) Encryption Process Using Two Strings.

This encryption process has two strings, a long and a short one, and they are used to encrypt/decrypt the content and to create the content's private key. As long as the two strings are in their original states they can be used for the purpose of encrypting/decrypting content, the same state used for encrypting must be used for decrypting, and at this state both strings are stable.

After the encryption process the short key is used to guide the algorithm in the removing of bytes from the long string and to create the content's private key. As bytes are removed from the long string it shrinks and at the same time the content's private key is created. After this process, the content's private key will point to the long string and hide the short string into the long string. And as this happens, the long string will expand to accommodate the insertion of the short string. Once the process ends, there will be two strings and they are said to be unstable, since they don't represent their original values. The two unstable strings can't be used for the purposed of decrypting a ciphertext that was encrypted, since they don't represent the same strings used originally.

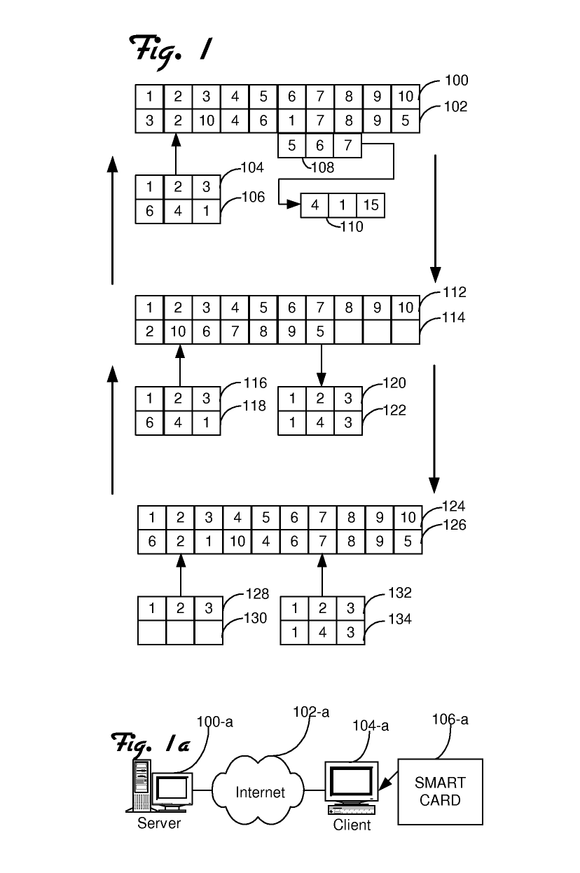

As we turn to FIG. 1 it illustrates the preferred embodiments of this invention. The top part of FIG. 1 illustrates a along string 102 with its content and each of its content's byte location 100; the short string 106 and its content's byte location 104 pointing to the long string 102. Next a plaintext string 108 is aligned with the long string 102 and the ciphertext 110 is thus produced. The middle part illustrates the two strings and the short one 118 pointing to the long one 114 and having the long string's bytes removed to form a third string 122. The bottom part illustrates the newly formed third string 134 pointing to the long string 126 and having the original short string 130 inserted into the long string 126. As we proceed this embodiments will be fully explained.

As we turn to FIG. 1a it illustrates a server computer 100-a communicating with a client computer 104-a through a Network/Internet 102-a and a smart cart 106-a attached at client computer 104-a. As anyone skilled in the art will readily knows that the server computer 100-a and the client computer 104-a have at least a memory unit, hard disk, keyboard, point device such as mouse, etc. Also, client computer 106-a has a card reader 106-a attached to it, or, if in case a card reader is not present values that represent the values on a smart card are stored at a storage device at client computer 104-a. This is one embodiments of this invention and it will be fully explained later on.

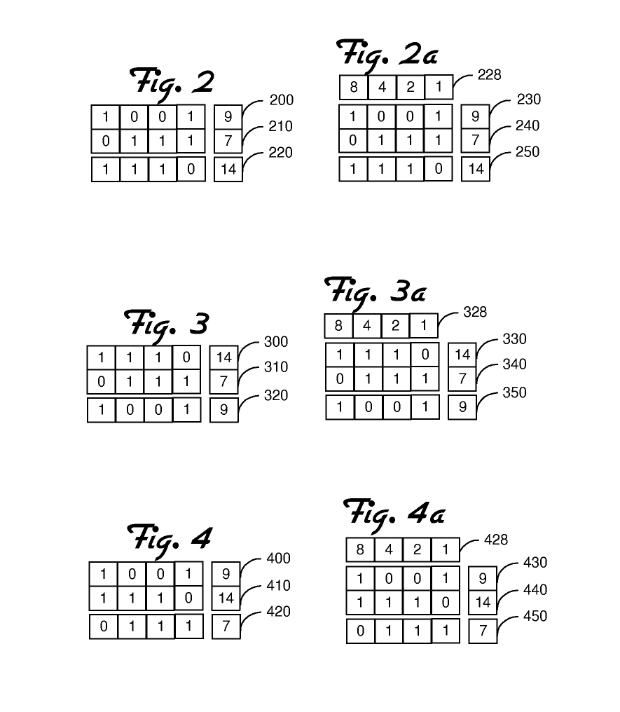

Before going any further, lets review how encryption can be performed into a string. There are many ways of hiding the original content (plaintext) and at the process getting the encrypted text (ciphertext). Some use means for scrambling the plaintext, others use mathematical formulas, algorithms, XOR, addition/subtraction, etc. For our encryption method we'll be using the XOR method. As we turn to FIG. 2 it shows two values being XOR-ed. The top value of “9” 200 is XOR-ed with the bottom value of “7” 210. The XOR process uses the binary representation of the values that it will process, that is, XOR. Each value processed by a computer is represented in its bytes equivalent (8 bits), since this is the only way a computer can perform its operation, and it is by using 0's and 1's (bits). For instance the value of “9” is represented by the byte value of “00001001” and the value of “7” is “00000111”. For our examples we're ignoring the four leftmost values since our examples uses small values. The same can be done using addition for encryption and subtraction for decryption, the objective still the same. XOR is the most used since the resultant value is the same length of the two values being XOR-ed and computer are good in doing XOR operations since it involves comparisons.

Now the XOR operation will produce the value of “1” any time at least one of the XOR-ed values has a byte value of 1's for one bit and a 0's for the other bit, and for all other bits combinations, its results will be 0's. Once two values are XOR-ed and the XOR result is applied to either of the original values in a second XOR operation, the operation result will produce the missing value—the value not taking part of the XOR operation. For example, FIG. 2 top value is “9” 200 and the next value is “7” 210 and the XOR result is “14” 220. Lets move to FIG. 3. Now, once the result “14” 300 is XOR-ed to the result of “7” 310 the result will be “9” 320. FIG. 4 shows the opposite. When the value of “14” 410 is XOR-ed to the value of “9” 400 the result will be “7” 420.

Since we've already discussed that 0's and 1's are the representation of computer operation, lets review FIG. 2a. The top 228 has the values starting from the right to the left, “1248”. In a binary representation it starts from the right (lower values) to the left (higher values). Since computers only deal with 0's and 1's, the first right most bit has the value of “1” and each of the following bit to the left will have the value of the first bit multiplied by “2” and the next value will be twice as large as the previous right value. And at any time there is the value of “1” for the bit, it will be added to any other value of “1” for any subsequent bit of the byte value. For instance, the value “9” 230 has a “1” for the first bit “1” and for the last bit “8”, in this case, the value of “1” is added to the value of “8” and the resultant value is “9”. One more example and it will be clear. Next the value of “7” 240 has 1's for the first three bits, “1”, “2” and “4”, and their sum is “7”. FIG. 2a represents the values for FIG. 2, the same applies to FIG. 3a and it has the values for FIG. 3 and FIG. 4a has the values for FIG. 4.

As we turn to FIG. 5 and it illustrates the two strings that was part of FIG. 1. The top string 510 has the top row 500 showing its location within the long string. The lower short string 540 has the top row 530 showing its location within the short string. Now the short string's byte values point to the long string's location representing that value (arrow 502). As we see, the value “6” of the short string 540 points to the location of “6” 500 of the long string 510. Since we're already reviewed the XOR process of two byte values. Lets move on and explain what happen once the short string 540 points to the long string location 500. Since the two strings at this point are in their original states, that is, they are stable. They can be used to encrypt another string, and the string with the values “5,6,7” 550 is XOR-ed with the long string's values of “1,7,8” 510 and the result is “4,1,15” 520 (arrow 504).

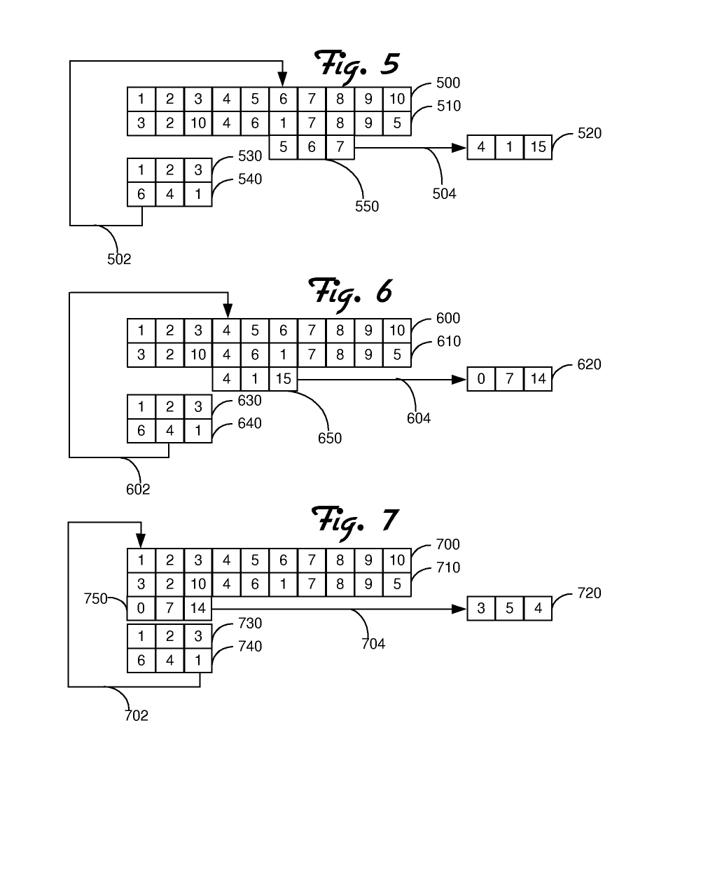

Next the same process is repeated for each value of the short string. And as it points to the long string the previous encrypted (XOR-ed) value is re-encrypted (re-XOR-ed). As we turn to FIG. 6 we see the second value of “4” of the short string 640 pointing to the position “4” 600 (arrow 602) of the long string 610 and re-XOR-ed the values “4,1,15” 650 with the values “4,6,1” of the long string 610. The final XOR-ed result is “0,7,14” 620 (arrow 604). The previous explanation applies to FIG. 7 as well and anyone skilled in the art will be able to follow the explanation given and fully understand its meanings as well. For our example we've used the byte's value of the short string to point to the long string, other means can be used for the same purpose as well, like, but not limited to: two bytes for other alphabets, characters or any alphabet and their representative values from the alphabet's table be used (ASCII, Unicode, etc.), two or more bytes for greater strength, etc.

We've shown values for the short and long string as numeric, numeric values are used here for sake of simplicity and easy of explaining. The values can be any byte value from 0 to 256 for a single byte encryption and for two byte encryption (encrypting foreign characters) the values will be up to 65536. In case that values other than numeric are used their corresponding values will be converted based on their table values of their respective character set, every programming language has functions for the specific of converting their values to a numeric corresponding. Furthermore, the long string that we've presented is very short, and once again, it is done as is for sake of simplifying our explanation, in reality, the long string has enough bytes so that the short string's bytes values will be able to point to any of its location or the long string can be duplicated and concatenated—joined together to form a longer string. The longer the long string is, the more encryption/decryption combination will be available, as for the short string, the longer it is, the stronger the encryption will be.

III) The Decryption Process Using Two Strings.

Since decryption is the reverse process of encryption. As we've seen with the XOR operations and once they are applied in the reverse, that is, the previous XOR result is XOR-ed again with the value that was used in the original XOR, the original result will be achieve, thus reproducing the original value, decrypting the ciphertext. When the encryption was performed, the process started at the short string leftmost value, first position, to the short string rightmost value, last position. As the decryption is performed, the opposite will happen, the process will start at the rightmost value, last position, to the leftmost value, first position.

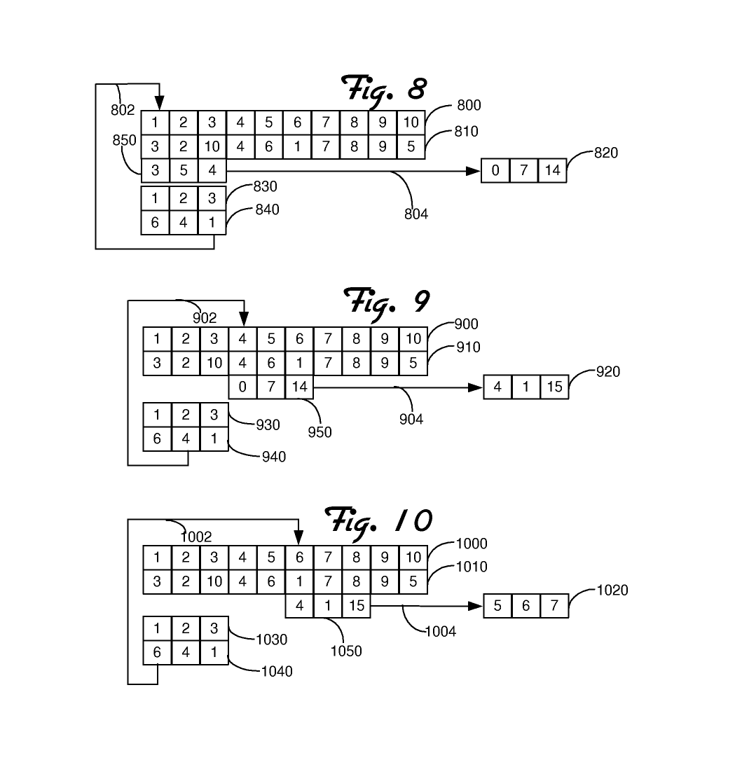

Lets keep at hand FIGS. 5-10. As we turn to FIG. 8 it illustrates the decryption process of the last encryption of FIG. 7, and its result was “3,5,4” 720. Now at FIG. 8 we have the value of “1” of the short string 840 pointing the to the position “1” of the long string 800 (arrow 802) and the previous XOR result “3,5,4” 850 aligned at the first position. As the two string values are once again XOR-ed “3,5,4” 850 and “3,2,10” 810 their XOR result will be “0,7,14” 820 and it is the same result 620 of FIG. 6.

As the decryption proceeds, the next short string value from the previous, right to left, is used to point to the long string and align the previously XOR-ed values to it, and that is showing in FIG. 9. As we see, FIG. 9 values “0,7,14” 950 XOR-ed with “4,6,1” 910 and the resultant values are “4,1,15” 920 and they are the same values 520 of FIG. 5. Finally as we turn to FIG. 10, the values of “4,1,15” 1050 are XOR-ed with the values “1,7,8” 1010 that in turn reproduces the original value of “5,6,7” 1020, and the resultant values are the same original values of “5,6,7” 550 of FIG. 5.

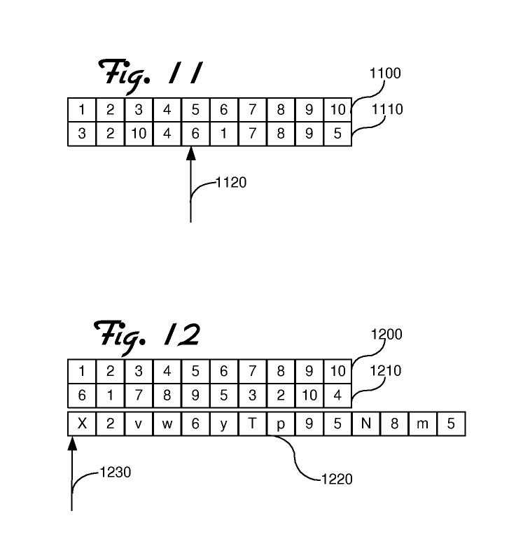

Before we go any further, lets review FIG. 11 and FIG. 12. FIG. 11 illustrates the long string 1110 and it is the same one that we've shown in the previous figures. It shows what happens when the short string points to it. The short string is not shown, only the arrow 1120 is shown as is when it was pointing from the short string. Now as we turn to FIG. 12, it illustrates what happens to the long string. As we look at it, the long string 1110 has the values of “3,2,10,4” before the arrow 1120, and the values of “6,1,7,8,9,5” starting at the arrow 1120 to the end of the string.

Now, FIG. 12 has the value of “6,1,7,8,9,5,3,2,10,4” starting at the long string 1210 first location. Once the short string points to the long string, the algorithm simply rotates the string, and by doing it this way, a string to be encrypted is placed at the location pointed at by the short string and all the values of the long string are used. As we see, there is a string being encrypted and it is longer than the long string, and the majority of the cases they are. Now the algorithm will encrypt the string by breaking it into smaller pieces that are the same size of the long string, and encrypt one piece at the time. E.g. the first part of the string being encrypted is “X2vw6yTp95” and encrypted (XOR-ed) with “6,1,7,8,9,5,3,2,10,4” and the last part of the string “N8m5” will be encrypted with “6,1,7,8”. Other means can be implement as well, like, just to use the right part of the long string “6,1,7,8,9,5” FIG. 11, or, to reproduce the long string as many times as necessary to provide a long enough string, or to just generate a very long string, in any case, the process and end result is the same. These are just a few ways of using the two-key pair. It is not to be understood as a constraint or a limitation, since anyone skilled in the art will be able to configure it in many other ways without departing from the true scope of the invention.

The advantage of using two strings to perform encryption is that a multiple level of security is achieved by re-encrypting the original text multiple times. Also, this method can be used to produce a global encryption system for an entire organization. For example, the organization can create a long string, lets say of “4000” bytes and each user PIN/Password can be converted into a numeric value format and the numeric value format be used to point to the long string and remove the short string for the user. Then the short string along with the long string can be used to perform encryption for all users. Furthermore, the two strings process is a very secure means of producing unlimited encryption key-pair combination, since an algorithm can be used to generate the two strings at runtime and each user having unique keys for automatically encrypting personal data. As we proceed, other means for using to encrypt user PIN/Password and other data and send them on an insecure communication channel will be fully explained as well.

Numeric values were used for the long and short strings. It was done this way for sake of simplicity. It can be any type of characters including foreign characters or a combination of characters and numbers. In case characters were used, their corresponding value from their respective table character-set values would've been used. There are many ways of converting character to their corresponding numeral values and it is well known to anyone skilled in the art.

There are many other arrangements that can be used to encrypt a plaintext using the method of two strings just described, anyone skilled in the art will be able to follow the explanations given and make full use of it without departing from the true spirit of this invention.

IV) Two Strings Private Key.

Up to this point we've described a encryption method making use of two strings, a long and a short one. Also, we already know that, to be able to encrypt and decrypt, both strings must be in their original states, that is, the same order used for encrypting must be used for decrypting as well. Now, to be able to make use of the encryption and transmit it to a recipient, the two strings cannot be into their original states, because if they are, anyone eavesdropping the communication will be able to decrypt the encrypted message. The solution is to scramble the two strings and encrypt the short string with the recipient public key. Then send the encrypted short string along with the scrambled long string and the ciphertext to the recipient. Other means will be shown where the private key is not sent and a PIN/Password is encrypted with the private key and the encrypted PIN/Password (ciphertext) is sent along with the long string in its original state without the private key.

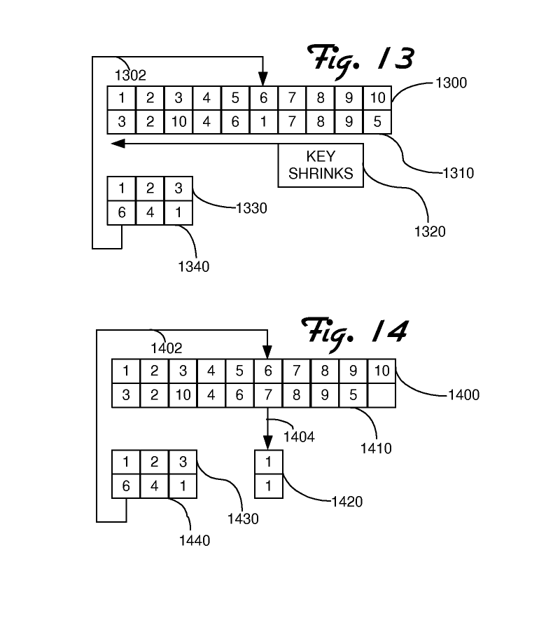

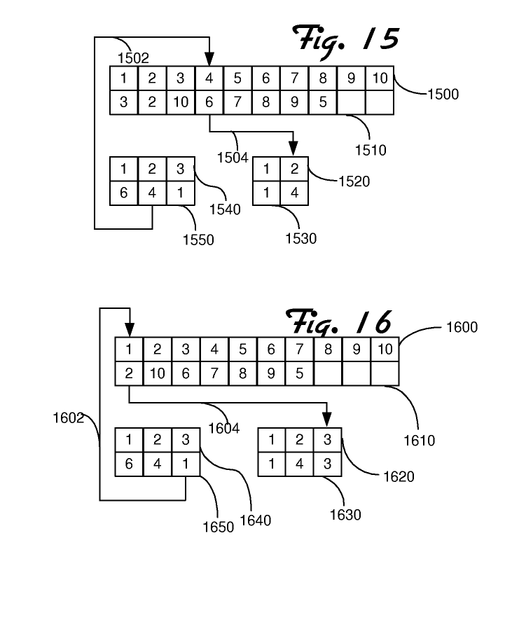

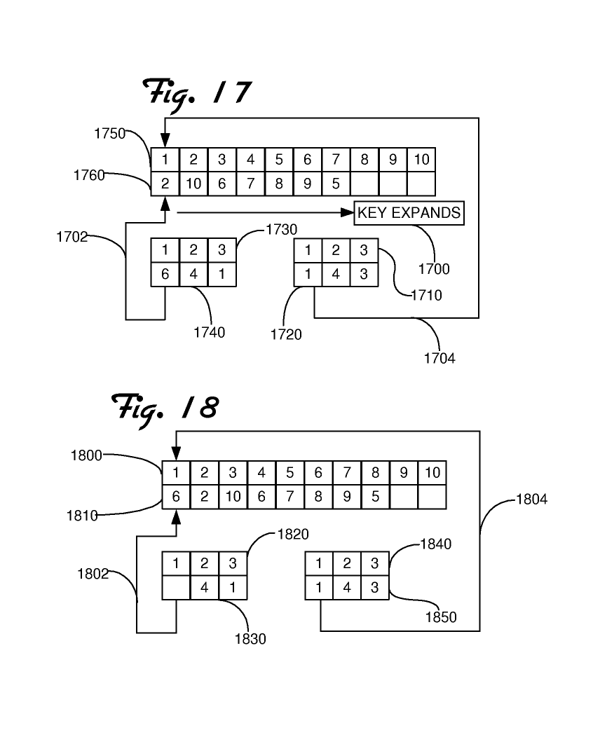

We'll be viewing FIGS. 13-16. As we turn to FIG. 13, it illustrates the same long string 1310 and short string 1340 that have been presented so far. Also, the is arrow 1320 is showing that the string (key) will shrink. FIG. 14 illustrates the short string 1440 and its first value “6” pointing to the location “6” of the long string 1410. As we look at FIG. 13 long string 1310 and at its position “6” (arrow 1302) we see the value of “1” at that position. Turning to FIG. 14 we notice that the long string 1410 has shrunk and the value “1” has been removed to form the new short string 1420. Proceeding to FIG. 15, we see that as the process continue the next position of the short string 1550 is used to point to the long string 1510. The value at that position (value of “4”—see FIG. 14 string 1410) is once again removed and the long string 1510 gets shrunk once again and the removed value is added to the new string 1530. The same explanation applies to FIG. 16 as well. At this point we have three strings: two short ones and one long. This is illustrated at FIG. 17. The first short string is the original short string 1740, and the other short string is the newly created string 1720 from the bytes removed from the long string 1760. Also, as we'll see, the long string will now expand arrow 1700.

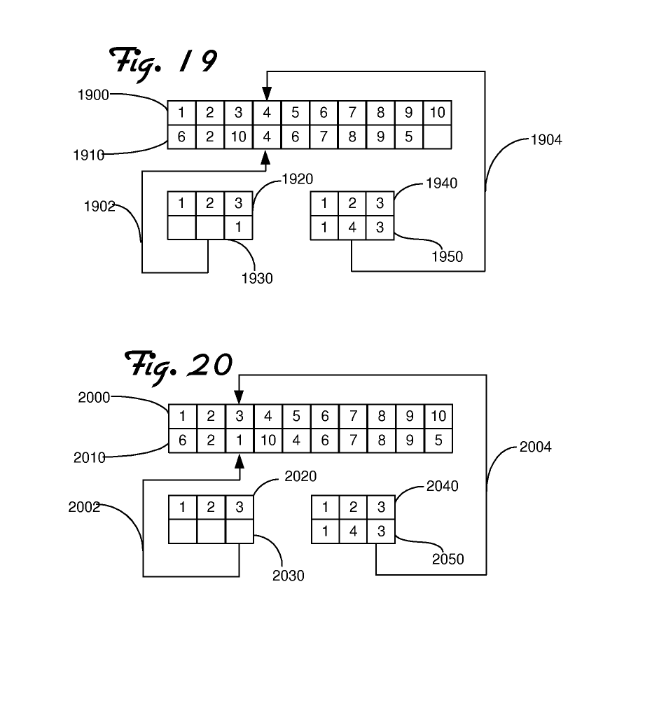

We'll be viewing FIGS. 17-20. Before proceeding lets review the long string 1760 of FIG. 17 and at its first position we see the value of “2”. Also, the original short string 1740 has the value of “6” at its first position. As we turn to FIG. 18, we have the newly created short string 1850, and starting with the value of “1” at its first position, it is pointing to the first position of the long string 1810 and it previously had the value of “2” as we saw at FIG. 17. Now, it has the value of “6” and it is the first value of the short string 1830, also, the long string 1810 has expanded to accommodate the new value. As we've seen with the previous examples, the new short string will point to the long string, starting from its first position and moving to its last position, and as it points to the long string the value of the original short string is inserted into the long string. We'll skip FIG. 19, since the previous explanations will apply to it as well and anyone skilled in the art will be able to follow the explanation given and fully understand it.

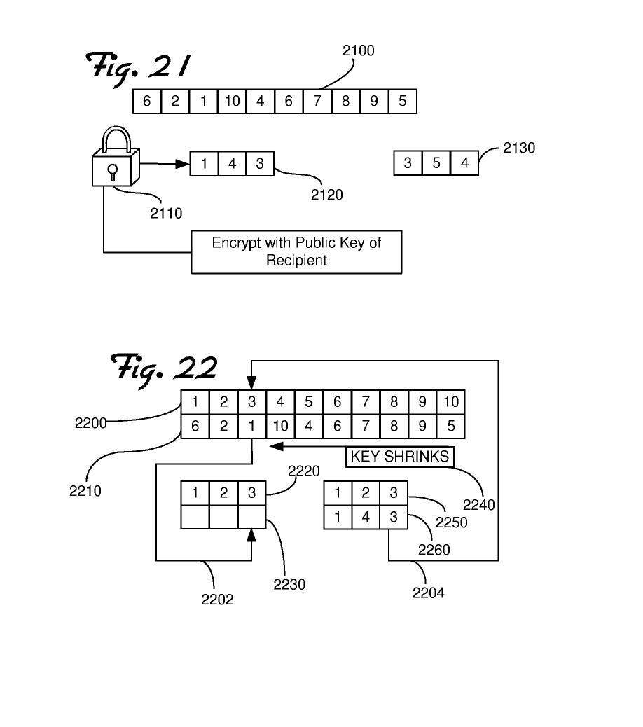

At this point we have two strings: a long and a short one. Lets turn to FIG. 20 and it illustrates the two strings: the short string 2050 was created from the original long string. The long string 2010 has the short string 2050 missing from it and it has the values of the original short string 2030 inserted in it. It can be said that the two strings are unbalanced, since neither one is in its original state. At their unbalanced states either string can be used as the content's private key. For our examples we'll be using the short one.

As we turn to FIG. 21 it illustrates the two strings along with the encrypted string (ciphertext). The short and the long strings are the same from the previous FIG. 20 (2050 and 2010 respectively), and the ciphertext 2130 is the same from FIG. 7 (720). Now, the short-key 2120 can be encrypted with the recipient's public key (as previously explained) 2110, the long scrambled string 2100, the short encrypted string 2120 and the ciphertext 2130 can be sent to the recipient without any concern if the communication is intercepted. Since anyone eavesdropping will not be able to decode the ciphertext 2130, because the short string is now encrypted with the recipient's public key and only the recipient will have the private key equivalent of the public key to decrypt it. Also, the ciphertext is encrypted with the short and long strings combination, since the only available string is the long one and it is unbalanced, thus, not allowing the decryption of the ciphertext.

As we already know, decryption is just the reverse of the process of encryption. And as we've seen that the two strings are used to encrypt and then they are scrambled to make the contents private key. Next, the content private key is encrypted with the recipient's public key; finally, the encrypted content's private key along with the scrambled long string and the encrypted content is transmitted to the recipient.

Once the recipient receives the encrypted content, the encrypted private key and the long string, the process to decrypt it will start. First, by decrypting the content's private key and it is done with the recipients private key related to the recipient's public key. Next, the content's private key will point to the long scrambled string and remove the short string from it, and as the short string is removed, the long string will shrink. Finally, the just removed short string will point to the long string and insert the content's private key into it, thus, recreating the two original strings: the long and the short one. At this point, the two strings are said to be stabilized once again, and ready to be used to decrypt the ciphertext.

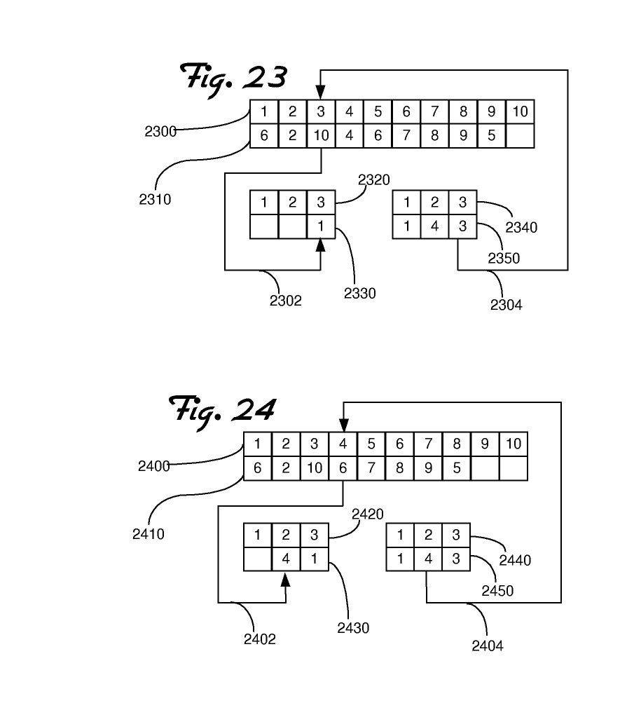

We'll be using FIGS. 22-25. As we turn to FIG. 22, it illustrates the two scrambled strings: the long 2210 and the short content's private key 2260. As we've said before, it indicates that once the process starts it will shrink 2240. Lets move on to FIG. 23. It illustrates the reverse process that we've described before when we were creating the content's private key. Now, the process will start in the reverse and that is, from the rightmost of the content's private key to the left most of it. Starting at the rightmost, on the last position the value of “3” points to the position “3” of the scrambled long string. As we look back to FIG. 22 and on the position “3” the value of “1” is present. Back to FIG. 23, the value of “1” has been removed from it and it is now on the rightmost of the new short string to be recreated 2330. As the values are removed from the long scramble string it will shrink.

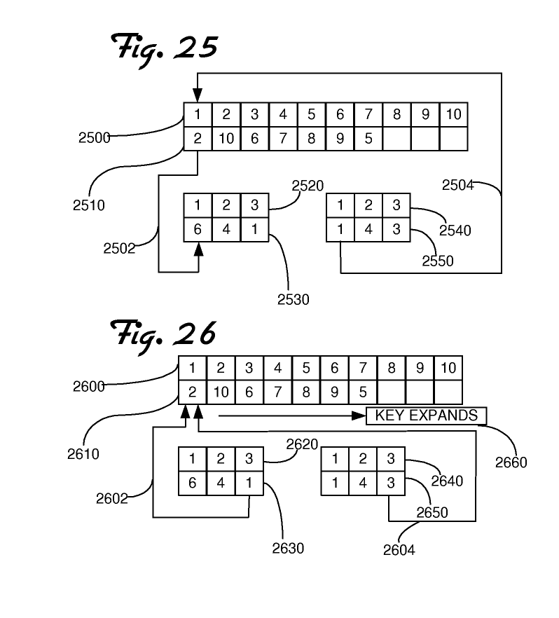

As we turn to FIG. 24 it illustrates the middle value of the content's private key 2450 and it has the value of “4”. As it points to the position “4” of the long scrambled string (arrow 2404) and it previously had the value of “4”, see FIG. 23. Now the value of “4” is removed from the long scrambled string 2410 and placed at the middle position (arrow 2402) of the original short string 2430. Once again, the long scrambled string 2410 shrinks. FIG. 25 illustrates the last value for the original short-key and as we look at FIG. 24 at the long scrambled string 2410 position “1” shows the value of “6” and at FIG. 25 it is placed at the first position of the original short string 2530. Once again the long scrambled string 2510 shrinks. At this point we have the original short string back (see FIG. 17 1740).

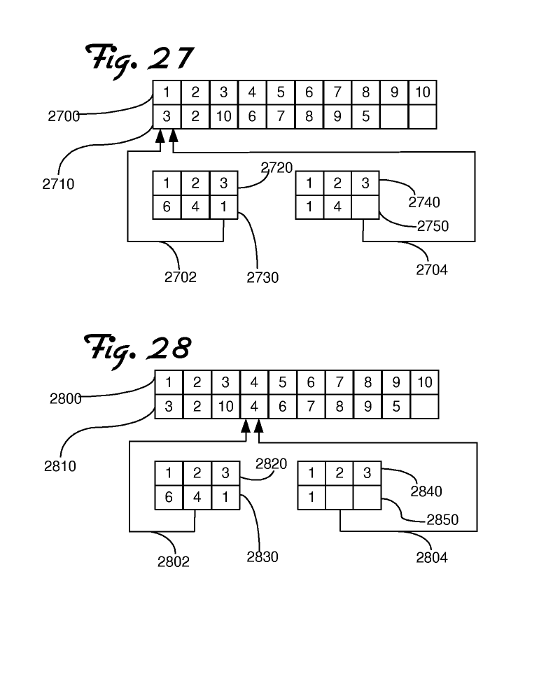

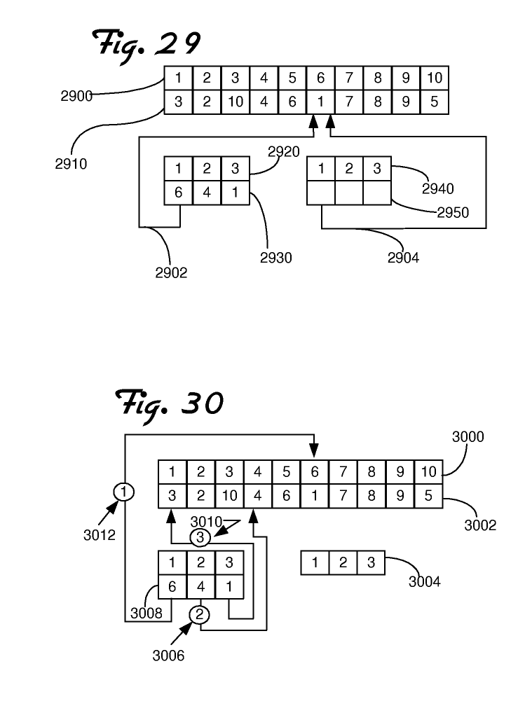

We'll be using FIGS. 26-29. As we turn to FIG. 26 it indicates that the long scrambled string 2610 will expand 2660. As before, the process will start at the rightmost position of the original short string to its leftmost position, and as values from the content's key 2650 is inserted into the long scrambled string 2610 it will expand to accommodate the new values, until all values from the content's key is inserted into it, and it become stable, that is, it has all of its original values. Since we've fully explained this process, we'll skip the FIGS. 27-28. Anyone skilled in the art will be able to follow the explanations already given and fully understand them as well.

As we turn to FIG. 29 it illustrates the two original strings: the long string 2910 and the short string 2930 and they are the original illustrated at FIG. 5 long string 510 and short string 540. Now, the recipients of the encrypted content (ciphertext) have all the required keys (original strings) to decrypt it and make use of the plaintext.

The advantage of using these two strings for encryption is that they can easily be generated for each user. Also, in the case of transmitting ciphertext over a communication channel, the keys can be changed as need to increase the security of ciphertext. We've shown examples using two short strings, in general use they are longer. For the long string it can be as long as needed for combination, usually, it is 1000 bytes or longer. The short key is for the strength of the encryption and it can be as long or as short as needed as well.

The short-key string can be used in different arrangements. Instead of being used to increase the strength of the algorithm, it can be used to encrypt long plaintext. It has been shown to encrypt the plaintext and subsequent type to re-encrypt the ciphertext for strength. Instead, another way is to encrypt the plaintext once when the short-key string points to the long key string for the first time, and after subsequent time the short key string points to the long key string, next block of plaintext is encrypted started at the new position pointed by the short-key string. E.g. the long key is “5,3,2,4,8,7,6,1,9,0”, the short string is “4,6,1,2” and the plaintext is “This is a plaintext example!” and the short-key string at the first time it points to the 4^{th} position of the long-key string “4” and the first part of the plain-text “This is” is encrypted with the values “4,8,7,6,1,9,0”, next, the short-key string points to the 6^{th} location of the long-key string “7” and “a pl” is encrypted with “7,6,1,9,0”, next, the short-key string points to the 1^{st} location and the values “ain text e” is encrypted with “5,3,2,4,8,7,6,1,9,0”, and finally, the short-key string points to the 2^{nd} position and the values “xample!” are encrypted with “3,2,4,8,7,6,1”. These are just a few examples and anyone skilled in the art will be able to make other arrangement without departing from the true spirit of this invention.

As we've shown the many uses of the two-string encryption algorithm and its flexibility. Now lets proceed and show some more examples and how it can enhance security in a non-secure communication channel like the Internet. Currently, HTTPS (Hyper Text Transmit Protocol Security) is used to send information like Personal Identification Number (PIN)/passwords and other sensitive information over an open network, like the Internet. HTTPS is very secure and require a great deal of processing power by both the client computer and the server computer communicating by this method. As with the proliferation of personal devices like PDA, cell phone and many others, the HTTPS process can very slow because these small devices have limited processing power. We'll show some more uses for the two-string encryption algorithm where PIN/Password and other sensitive information can be encrypted without requiring the use of HTTPS protocol.

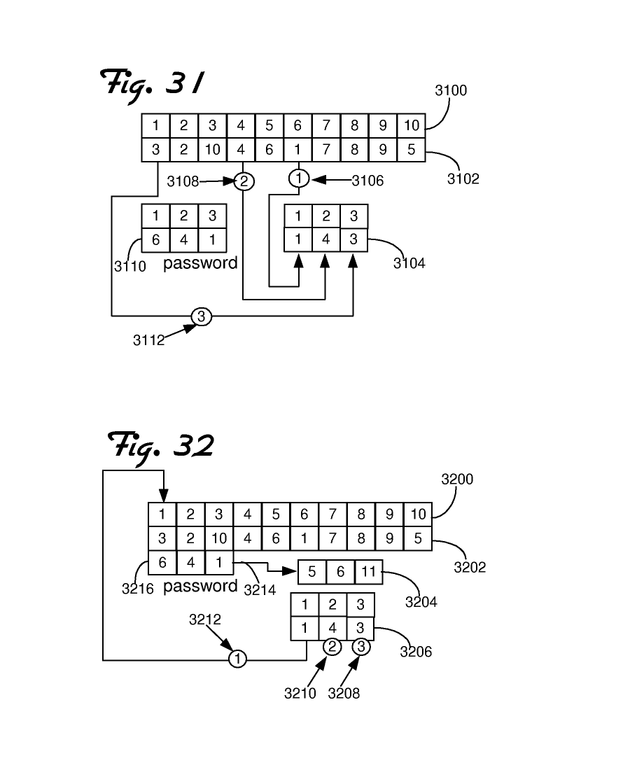

As we turn to FIG. 30 and it illustrates the original long string 3002 and the short string 3008 (both explained elsewhere). Since the process has already been explained more than once before, lets just point to the short string's bytes values 3008 pointing to the long string positions 3002. There are three steps and they are: step 1 3012, step 2 3006 and step 3 3010 and they point to the long string's 3002 positions based on the short string's bytes values 3008. As we turn to FIG. 31 each of the values of the long string 3102 is copied (not removed this time around) to form a third string 3104. The same three steps are required for each step of FIG. 30 and they are: step 1 3106, step 2 3108 and step 3 3112. Lets look back at FIG. 30 and the three steps pointed to “1”, “4” and “3” respectively. Back to FIG. 31 they are the same value of the new short string 3104. This time around the newly formed short string bytes are simply copied from the long string without destabilizing it.

Lets go back to FIG. 1a and it illustrates what we've already explained elsewhere. Lets just review the process of a user login in from the client computer 104-a to the server computer 100-a through the Internet 102-a. Now, the client computer 104-a may or may not have a smart card reading device to read the smart card 106-a. If one is present the user will simply swipe the smart card 106-a and its values (long string) will be read by the client computer 104-a, otherwise, the client computer 104-a may have the long string values stored therein or one will be runtime generated. In any case, the process will be the same. The login process involves the server computer 100-a having a user's PIN/Password stored therein and the user at the client computer 104-a logins in into the server computer 100-a by supplying the same PIN/Password that is stored at the server computer 100-a and assigned to the user at the client computer 104-a. If the user supplied PIN/Password matches the one stored at the server computer 100-a, server computer 100-a will authenticate the user by giving permission to use its resources. As we've explained elsewhere, the user PIN/Password will be sent from client computer 104-a to server computer 100-a through the network/Internet 102-a by using the HTTPS protocol for security reasons.

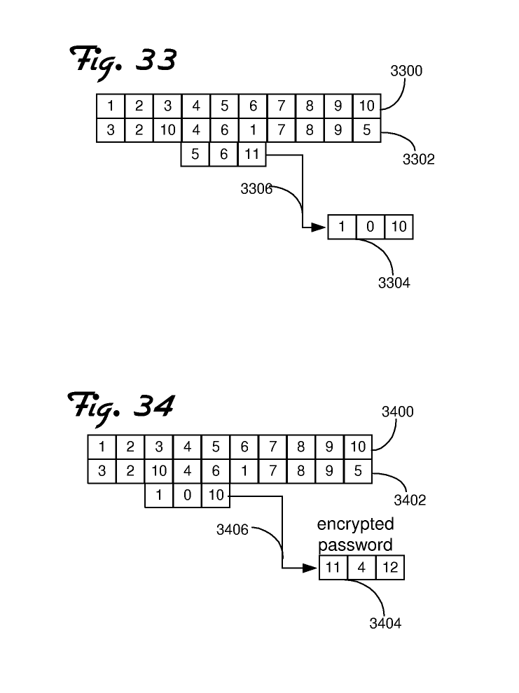

Lets turn to FIG. 32 and it illustrates the short key 3216 which is a user PIN/Password that we've already discussed and it is encrypted with the long string 3202 based on the newly formed short string bytes values 3206 pointing to it. This process has already been fully covered, lets skip FIG. 33 since anyone with skill in the art will be able to fully understand its process as well. As we turn to FIG. 34 illustrates the final stage where the user PIN/Password is finally encrypted 3404.

Securing a PIN/Password and Sending it to a Server—As we have already explained a user's login process, we know that the long string didn't changed, also, we know that the user PIN/Password was used to point to the long string and copy its bytes values to form the new string. Now we have the long string and the new short string in their original states and as we already know, they cannot be present while being transmitted in a non-secure communication channel from the client to the server computer, since anyone eavesdropping the communication will be able to decrypt the ciphertext—a user PIN/Password in our example. Also, as we already know that a server computer where a user is to login in has the user PIN/Password stored therein, in our example, the client can sent the encrypted user's PIN/Password and the long stable string to the server without the short string. Since anyone eavesdropping the line will not have any way of decrypting the PIN/Password and since the server has the user's PIN/Password, all the server will need to do is to use the user's PIN/Password that is stored therein and point to the long string and recreate the short string, then use it to decrypt the user's PIN/Password, if it is a match, the user is authenticated and permitted to user the server computer resources. The long string sent to the server 100-a by the client computer 104-a can be the one stored at the SMART CARD 1006-a, be stored at the client computer 104-a or be runtime generated the client computer 104-a. Lest review the process. The user's PIN/Password is used to point to the long string and copy its byte's values and create a short string. Next the newly created short string along with the long string will encrypt the user's PIN/Password and sent it along with the long stable string over a non-secure communication channel to the server computer. The server computer will use the user's PIN/Password to point to the long stable string and copy its bytes values and recreate a short string. Finally, the short string along with the long string will be used to decrypt the user's PIN/Password. Still a safer means for encrypting the PIN/Password and sending it across a non-secure channel would be to divide the PIN/Password into two halves and have one half to point to the long string and remove the short string then the short string along with the long string will encrypt the other half of the PIN/Password and send it (the encrypt half only) along with the long stable string and at the receiving server computer the reverse process will take place as it has already been explained elsewhere. In the case of a smart card, the long string will be available for all smart card and the authenticating server as well, and of course, in the case of smart card and the login in means that we've just described, a user ID of some sort will be part of the process as well.

Securing a PIN/Password and Storing it at a Client—In many cases, the user's entered PIN/Password needs to be saved at the client computer as well without compromising its security. In addition to the above means (Securing a PIN/Password and Sending it to a Server), a second short string can be derived (computer generated) and it can be used to encrypt/decrypt the user's PIN/Password and have it (ciphertext) stored at a cookie variable, or any other means, at the client computer. The second short string, not the one derived with the user's PIN/Password, can be sent along with the long string and the encrypted user's PIN/Password to the server computer over a non-secure communication channel, both strings will be in their stable states and they will not compromise security, since they both are used only by the client computer. In subsequent trips to the client computer, the server computer may pass them both back in a hidden form element, or any other means, as needed. The client computer will use them to decrypt/encrypt and save the user's PIN/Password or any other sensitive information needed by the client computer and stored therewith.

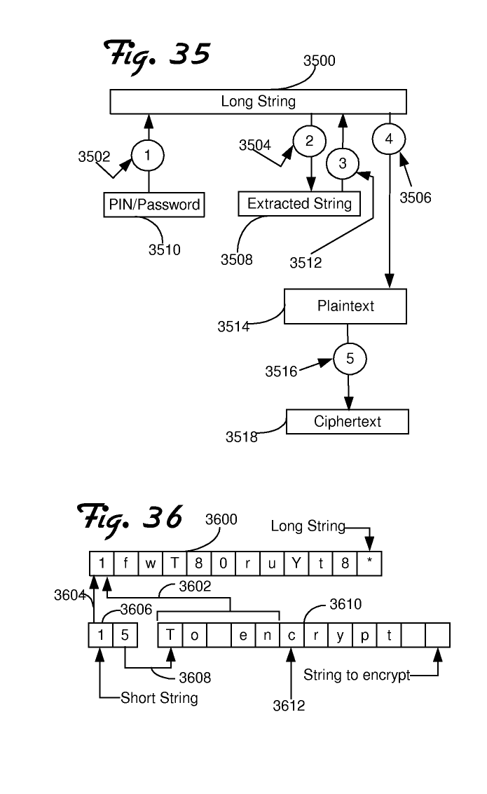

Securing Plaintext—The same process that was used to encrypt the user PIN/Password can be used to encrypt plain text before having it transmitted on an open non-secure channel as well. As we turn to FIG. 35 it show the user PIN/Password 3510 pointing 3502 to the long string 3500 and extracting a copy of the long string's 3500 bytes values to form a new short string 3508 (arrow 3504) then pointing 3512 to the long string 3500 to align the plaintext 3514 and finally having the ciphertext 3518 (arrow 3516) from the plaintext 3514. Next, plaintext 3514 is encrypted using the same means as previously explained and the ciphertext 3518 can be transmitted along with the long string 3500 in an open un-secure network/Internet without the possibility of an eavesdropper to be able to decipher the ciphertext. Once received by the server computer, it will use the user's PIN/Password value stored therein and point the long string and get a copy of the original short string that was used for the encryption process 3508 and decrypt the ciphertext 3518 thus producing the original plaintext 3514.

Increasing Encryption Strength and Speed—There are many ways for implementing the two-string encryption algorithm and many ways to increase its speed and strength as well. As we turn to FIG. 36 it illustrates just one technique that can be implemented and used for that purpose. As it is illustrated, there are a long string 3600, a short string 3606 and a string to encrypt 3610. The short string 3606 has just two bytes—in real application it can have any number of bytes and in general it will be large string. Now the short string 3606 has its first byte value “1” pointing to the first position (arrow 3604) (byte “1”) of the long string 3600 and the second byte of the short string 3606 has the byte value of “5” and it is pointing (arrow 3608) to the first position of the string to encrypt 3610, five bytes “To enc” from the string to encrypt 3610 will be aligned (arrow 3602) with the first position of the long string 3600. Next, the values “To enc” of the string to encrypt 3610 will be XOR-ed with the values “1fwT8” of the long string 3600 and the pointer 3612 will point to the next position at the string to encrypt 3610 where the next byte values of the short string 3604 will point—only two bytes are present for sake of simplicity and not intended to obscure this invention. For instance, if a 3^{rd} and 4^{th} bytes were present, the 3^{rd} byte's value would have pointed to the long string 3600 and the 4^{th} byte's value would have been used to fetch the next portion of the string to encrypt 3610 and starting at the position where the pointer 3612 is pointing to at the string to encrypt 3610. Anyone with the skills in the art will be able to follow the explanations just given be able to fully implement other techniques as well without departing from the true spirit of the teachings of this invention.

Securing Content at a Computer—The more we review the two-string encryption process the more uses become apparent. It can be used to protect a user computer's contents, software, personal information, etc., as well. Lets move on and explain how this process happens. A two-strings pair is created at the time a user first use the computer device and provides a user's PIN/Password. Now, the user PIN/Password will be used to point to the long string and copy bytes from the long string and form a third string. The newly formed third string will be used to point to the long string, align and encrypt the second short string (the one that is part of the pair) then have it saved therein along with the long string. Now, the long string will be in its original states and the short string encrypted based on the user's PIN/Password and the user's PIN/Password does not need to be saved because the encryption/decryption is based in the encrypted short string of the long string pair. To be able to encrypt/decrypt, the user must be logged in and the user's PIN/Password will be used to decrypt the short encrypted string and it along with the long string will be used to encrypt/decrypt. Once a user changes his/her PIN/Password, the old PIN/Password will be used to decrypt the short string, next, the new PIN/Password will be used to encrypt the short string and have it saved therein once again.

Throughout our examples and explanations we've used the term PIN/Password. As it will be readily apparent to the one with the skill of the art, the same process can be used to secure any type of user-sensitive information, like but not limited to: social security, banking account, user's personal medical records, etc. Also, the process can be implemented at the server and at the client software platform.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A two strings encryption means, comprising:
a string to encrypt having at least a first byte;
a first string having a plurality of bytes;
a second string having at least a second byte;
the byte value of said at least second byte of said second string is used to point to a location at said first string;
said at least first byte of said string to encrypt is aligned with said location of said first string where said byte's value of said at least second byte of said second string is pointing to;
means to perform an operation with said at least first byte of said string to encrypt and said byte of said first string where said at least first byte of said string to encrypt is aligned with; and
said operation will produce an encrypted byte value (ciphertext).

2. The two strings encryption means according to claim 1, wherein said operation is an XOR (Exclusive Or) logical operation.

3. The two strings encryption means according to claim 1, further comprising:
a byte is removed from said location of said first string where said byte's value of said at least second byte of said second string is pointing to;
said removed byte from said first string is used to form a third string;
said third string byte's value is used to point to a location at said first string corresponding to said byte's value of said third string; and
said at least second byte from said second string is inserted at said location of said first string where said byte's value of said third string is pointing to.

4. The two strings private key means according to claim 3, wherein said third string is a private key.

5. The two strings private key means according to claim 3, wherein said third string and said first string are unstable.

6. The two strings private key means according to claim 3, wherein said first string is a private key.

7. The two strings private key means according to claim 3, wherein said first string expands when said at least third byte from said second string is inserted into said first string.

8. The two strings private key means according to claim 3, wherein said first string shrinks when said byte of said first string is removed to form said third string.

9. The two strings private key means according to claim 1, wherein said first string and said second string are stable.

10. A two strings decryption means, comprising:
a string to decrypt having at least a first byte;
a first string having a plurality of bytes;
a second string having at least a second byte;
the byte's value of said at least second byte of said second string is used to point at a location of said first string;
said at least first byte of said string to decrypt is aligned with said location of said first string where said byte's value of said at least second byte of said second string is pointing to;
means to perform an operation with said at least first byte of said string to decrypt and said byte's value of said first string where said byte's value of said at least first byte of said string to decrypt is aligned with; and
said operation will produce the original value of said byte of said encrypted string before it was encrypted.

11. The two strings decryption means according to claim 10, wherein said operation is a XOR (Exclusive Or) logical operation.

12. The two strings decryption means according to claim 10, wherein said first string and said second string are stable.

13. A two strings private key means, comprising:
at least a first string having a plurality of bytes;
at least a second string having at least a first byte;
said at least first byte's value of said at least second string points to a location at said at least first string;
a byte is removed from said first string where said at least first byte's value of said second string is pointing to;
said removed byte from said first string is used to form a third string;
said third string byte's value is used to point to a location at said first string; and
said at least first byte from said second string is inserted into said location at said first string where said byte's value from said third string is pointing to.

14. The two strings private key means according to claim 13, wherein said third string is a private key.

15. The two strings private key means according to claim 13, wherein said first string and said third strings are unstable.

16. The two strings private key means according to claim 13, wherein said first string is a private key.

17. The two strings private key means according to claim 13, wherein said first string expands when said byte from said second string is inserted into said first string.

18. The two strings private key means according to claim 13, wherein said first string shrinks when said byte from said first string is removed to form said third string.

19. A means for sending sensitive data over a non-secure communication channel, comprising:
at least a first string having a plurality of bytes;
at least a second string having at least a first byte;
the byte's value of said at least first byte of said at least second string is used to point to a location at said first string;
a byte's value at a location of said at least first string where said byte's value of said at least first byte's value of said at least second string is pointing is copied to form a third string;
said byte's value of said third string is used to point to a location at said first string;
said at least first byte's value of said at least second string is aligned with said location at said first string where said byte's value of said third string is pointing to;
means to perform an operation with said at least first byte's value of said at least second string and said byte's value of said at least first string where said at least first byte's value of said at least second string is aligned with; and
said operation will produce an encrypted byte's value (ciphertext).

20. The means according to claim 19, further comprising:
means to transmit said encrypted string and said at least first string to a computer;
said computer having a copy of said second string stored therein;
said computer uses the byte's value of said second string stored therein to point to a location at said received first string;
a byte is copied from a location where said byte's value of said second string stored therein is pointing to at said received first string and a third string is formed therein;
the byte value of said formed third string therein is used to point to a location at said received first string;
the encrypted byte's value of said received encrypted string from said computer is aligned with said location at said received first string where said byte's value of said third string formed therein is pointing to;
means to perform an operation with said received encrypted string's byte value and said byte's value of said received first string where said received encrypted string's byte value is aligned with; and
said operation will produce the original byte's value of said encrypted string's byte before it was encrypted.

21. The means according to claim 20 wherein said operation is an XOR (Exclusive Or) logical operation.

22. The means according to claim 19, further comprising:
means to transmit said encrypted string to a computer;
said computer having a copy of said second string and a copy of said at least first string stored therein;
said computer uses the byte's value of said second string stored therein to point to a location at said first string stored therein;
a byte is copied from a location where said byte's value of said second string stored therein is pointing to at said first string stored therein and a third string is formed therein;
the byte value of said third string formed therein is used to point to a location at said first string stored therein;
the encrypted byte's value of said received encrypted string from said computer is aligned with said location of said first string stored therein where said byte's value of said third string formed therein is pointing to;
means to perform an operation with said received encrypted string's byte value and said byte's value of said first string stored therein where said received encrypted string's byte value is aligned with; and
said operation will produce the original byte's value of said encrypted string's byte value before it was encrypted.

23. The means according to claim 22 wherein said operation is an XOR (Exclusive Or) logical operation.

24. A means for sending sensitive data over a non-secure communication channel, comprising:
at least a first string having a plurality of bytes;
at least a second string having at least a first byte;
at least a third string having at least a second byte;
the byte's value of said at least first byte of said at least second string is used to point to a location at said first string;
a byte's value at the location of said at least first string where said at least first byte's value of said at least second string is pointing is copied to form a forth string;
said byte's value of said forth string is used to point to a location at said first string;
said at least second byte of said at least third string is aligned with said location at said first string where said byte's value of said forth string is pointing to;
means to perform an operation with said at least second byte's value of said at least third string and said byte's value of said at least first string where said at least second byte of said at least third string is aligned with; and
said operation will produce an encrypted byte's value (ciphertext).

25. The means according to claim 24, further comprising:
means to transmit said encrypted string and said at least first string to a computer;
said computer having a copy of said second string stored therein;
said computer uses the byte's value of said second string stored therein to point to a location at said received first string;
a byte is copied from said location where the byte's value of said second string stored therein is pointing to at said received first string and a third string is formed therein;
said byte's value of said third string formed therein is used to point to a location at said received first string;
said received encrypted string's byte value is aligned with said location of said received first string where said byte's value of said third string formed therein is pointing to;
means to perform an operation with said received encrypted string's byte value and said byte's value of said received first string where said received encrypted byte's value is aligned with; and
said operation will produce the original byte's value of said received encrypted string's byte value before it was encrypted.

26. The means according to claim 25 wherein said operation is an XOR (Exclusive Or) logical operation.

27. The means according to claim 24, further comprising:
means to transmit said encrypted string value to a computer;
said computer having a copy of said second string and a copy of said first string stored therein;
said computer uses the byte's value of said second string stored therein to point to a location at said first string stored therein;
a byte is copied from said location where the byte's value of said second string stored therein is pointing to at said first string stored therein and a third string is formed therein;
said byte's value of said third string formed therein is used to point to a location at said first string stored therein;
said received encrypted string's byte value is aligned with said location of said first string stored therein where said byte's value of said third string formed therein is pointing to;
means to perform an operation with said received encrypted string's byte value and said byte's value of said first string stored therein where said encrypted string's byte value is aligned with; and
said operation will produce the original byte's value of said received encrypted string's byte value before it was encrypted.

28. The means according to claim 27 wherein said operation is an XOR (Exclusive Or) logical operation.
